(19) United States
(12) Patent Application Publication
(10) Pub. No.: US 2018/0325055 A1
(43) Pub. Date: Nov. 15, 2018

(54) Aeroponic apparatus

(71) Applicant: Gilad Krakover, HaSharon (IL)

(72) Inventor: Gilad Krakover, HaSharon (IL)

(21) Appl. No.: 15/594,683

(22) Filed: May 15, 2017

(51) Int. Cl. A01G 31/06; A01G 9/02

(52) U.S. Cl. CPC A01G 31/06; A01G 31/02; A01G 9/02

(57) ABSTRACT

The objective of the present invention to provide an aeroponic plant growing system with improvement in efficiency and performance. In one aspect of the present invention, a water pump located outside of the aeroponic container is used to propel the liquid cycling throughout the system. Another aspect of the present invention is the design of planting trays that are detachable, portable, and enabling higher planting density by using rooting tubes that prevent the roots of neighboring plants from merging with each other. The rooting tubes are also designed to optimize mist exposure of the roots while providing effective root separation.

### REFERENCE TO RELATED APPLICATIONS

This is a first-filed application.

### BACKGROUND OF THE INVENTION

### Field of the Invention

The present invention relates to the field of horticultural systems and methods. Particularly, the present invention relates to aeroponics, in which a combination of water, oxygen, and nutrients is provided directly at the root system of a plant.

### MOTIVATION AND DESCRIPTION OF RELATED ART

Aeroponics is a method of growing plants where the roots are not contained in a medium such as soil, water baths, or other root bearing substance. In aeroponic growing systems, plants are grown in a closed or semi-closed environment by spraying the plant's roots with water or water-based solution. Aeroponic systems provide many desirable advantages over medium-based growing systems. For example, aeroponic growing increases aeration and delivers more oxygen to plant roots, stimulating growth and helping to prevent pathogen formation. Aeroponics can also limit disease transmission since plant-to-plant contact is reduced. Due to the disease-free environment that is unique to aeroponics, many plants can grow at higher density compared to traditional forms of cultivation such as soil or hydroponics.

Aeroponic systems can be used to support the growth of plants from seed germination or from cuttings. Particularly, this technique has shown great advantages in propagating plants from cuttings, known as cloning. Aeroponics allows the whole process of plant cloning to be carried out in a single, automated unit, by initiating faster and cleaner root development through use of a sterile, highly oxygenated, and moist environment. Aeroponic systems also produce cloned plants with healthier root systems. When aeroponically cloned plants are transplanted into soil, they are not susceptible to wilting and leaf loss or loss due to transplant shock, and they are less likely to be infected with pathogens when placed in the field.

Various aeroponic plant growing systems have been available or have been disclosed. These systems provide varying degrees of success. However, there are also limitations of the currently available aeroponic plant growing systems, including limitations in the ease or efficiency in operation and maintenance, limitations in the density of plants that can be grown, insufficiency in system reliability and effectiveness, and limitations on affordability and portability. Therefore, there is continued need for aeroponic plant growing systems that offer improvement in the aspects mentioned above.

### SUMMARY OF THE INVENTION

The objective of the present invention to provide an aeroponic plant growing system with improvement in efficiency and performance.

In one aspect of an embodiment of the present invention, a water pump located outside of the aeroponic container is used to propel the liquid cycling throughout the system. This represents a departure from many currently available aeroponic systems, where the pump is located inside of the container and submersed in the liquid. There are a few advantages associated with an external pump arrangement. For example, since the engine in the pump always generates heat, an internal and submersed pump will heat up the solution and raise the ambient temperature within the aeroponic container. This is likely detrimental to the health and growth of the root systems by overheating. In contrast, a pump external to the aeroponic container, as embodied in the present invention, dissipates heat outside of the aeroponic container and thus does not affect the water temperature or the ambient temperature surrounding the plants under care. In addition, a pump external to the water tank allows for straightforward customization of the aeroponic apparatus with connections to additional components, such as inline filters, UV light sterilizers, water temperature controllers, and so on. Furthermore, placing the pump outside of the aeroponic apparatus significantly reduced the required size and water usage of the aeroponic container, since there's no need to contain and immerse the pump in the container. As a result, the present invention allows designs of compact and resource-efficient aeroponic apparatus.

Another aspect of some embodiments of the present invention is the use of a customized compact high-pressure pump. In one preferred embodiment, a mini diaphragm design is used. The motor output power and heat sink parameters can be customized to optimize the pump performance for a specific aeroponic apparatus model with required water flow per minute. With an optimized water pressure, the air flow propelled by the pressured water spray lowers the ambient temperature inside the aeroponic container. This small cooling effect is ideal for the health and growth of the root systems for many plants, and is achieved here without additional cooling systems. In addition, the higher output pressure of the pump coupled with the carefully chosen manifold nozzle design produces a fine spray mist—with an average droplet size of around or below 40-50 microns. The small droplet size is associated with greater surface area and better efficiency to oxygenate and provide nutrients to the plant stems and roots.

Another aspect of the present invention is the design of planting trays that are detachable, portable, and enabling higher planting density by using rooting tubes that prevent the roots of neighboring plants from merging with each other. The rooting tubes are also designed to optimize mist exposure of the roots while providing effective root separation.

The above invention aspects will be made clear in the drawings and detailed description of the invention.

### BRIEF DESCRIPTION OF THE DRAWINGS

FIG. 1 is a perspective view of an embodiment of the aeroponic apparatus of the present invention.

FIG. 2 is an exploded view of an embodiment of the aeroponic apparatus of the present invention.

FIG. 3 is a perspective partial view of an embodiment of the aeroponic apparatus, illustrating the arrangement of the water tank, planting tray, and manifold.

FIG. 4 is a diagram showing the water cycle of an embodiment of the aeroponic apparatus of the present invention.

FIG. 5 is a perspective view of an embodiment of the planting tray of the present invention.

FIG. 6 (a) is a perspective view of an embodiment of the stem collar.

FIG. 6 (b) is a top view of the stem collar.

FIG. 7 (a) is a bottom perspective view of an embodiment of the planting tray of the present invention, showing the rooting tubes and their openings.

FIG. 7 (b) is a diagram illustrating the directional arrangement of the rooting tube openings.

### REFERENCE NUMERALS IN THE DRAWINGS

Reference is now made to the following components of embodiments of the present invention:
100 Aeroponic apparatus
110 Humidity cover
112 Humidity cover vent
113 Vent lid
210 Water tank
211 Mounting pin
212 Tank inlet
213 Tank outlet
260 Planting tray
262 Planting tray base board
264 Planting tray handle
265 Insert opening
266 Insert depress
268 Planting tray clip
270 Rooting tube
272 Rooting tube opening
280 Stem collar
282 Stem collar center hole
283 Stem collar slit
310 Pump
320 Inline water filter
330 Manifold
332 Nozzle
333 Tightening cap
340 Connection pipe
344 Inlet pipe
345 Outlet pipe

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

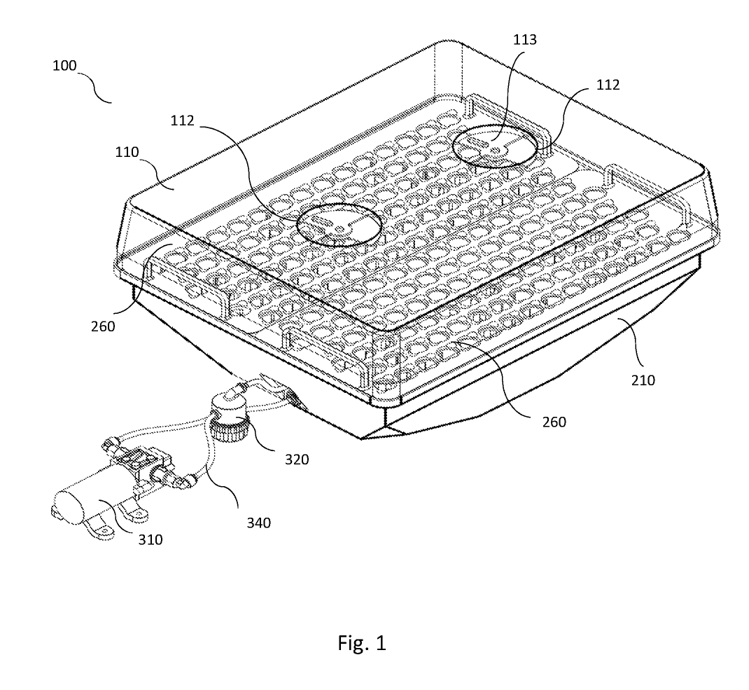

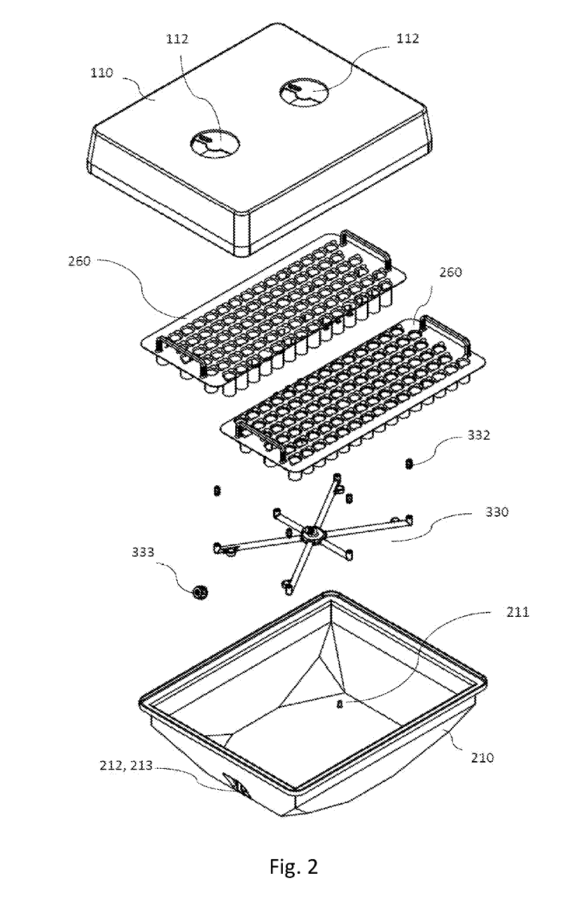

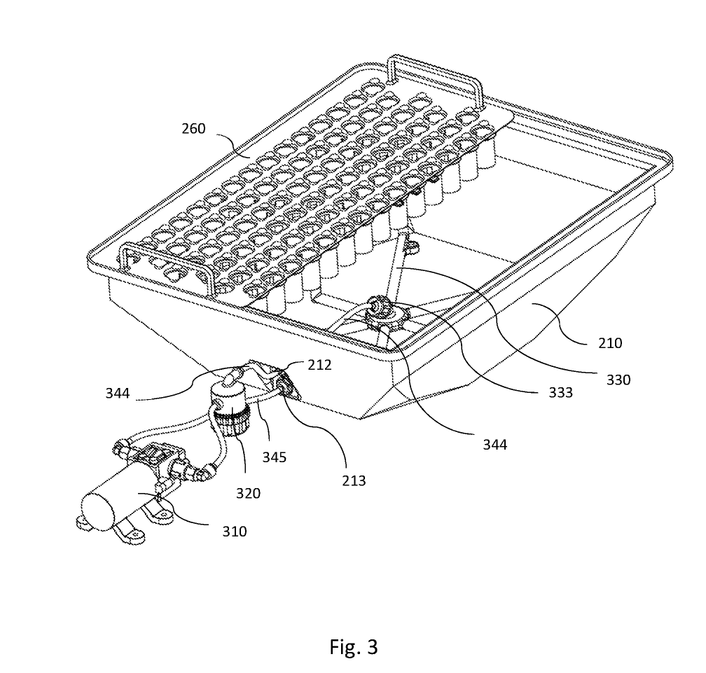

FIGS. 1-3 show the main components of an embodiment of the aeroponic apparatus 100. FIG. 1 is a perspective view of the aeroponic apparatus 100 when the main components are assembled together. FIG. 2 is an exploded view of the aeroponic container to illustrate its interior structure. FIG. 3 is a perspective view of a partial assemble of the aeroponic apparatus 100, showing the arrangement of the main components for water cycling.

As shown in FIG. 1, the aeroponic apparatus 100 comprises a humidity cover 110, a water tank 210, a pump 310, an inline water filter 320, and connection pipes 340. In a preferred embodiment, the pump 310 and the inline water filter 320 are external to the water tank 210. In another preferred embodiment, the humidity cover 110 is made of transparent or semi-transparent material, thus providing light exposure to assist plant growth as well as visualization of the interior of the aeroponic apparatus. In yet another preferred embodiment, the humidity cover 110 comprises one or more vents 112 with rotatable vent lids 113 to allow controlled ventilation of the aeroponic apparatus.

As shown in the exploded view of the aeroponic container in FIG. 2, the aeroponic apparatus 100 further comprises one or more planting trays 260. With the use of matching inserted stem collars, the planting trays 260 support the plant cuttings. A manifold 330 with nozzles 332 and tightening cap 333 are located under the planting trays 260 to spray water or nutritional solution to the plants. Mounting pins 211 are used to fix the manifold 330 to the tank 210. In the embodiment shown in FIG. 2, 4 mounting pins are used close to the corners of the tank 210 (3 of which are hidden from view.) It will be made clear in the present disclosure that a fixed position of the manifold 330 is important for optimizing performance of the aeroponic apparatus. The water tank 210 comprises a tank inlet 212 and tank outlet 213. In the example shown in this figure, two planting trays 260 are used. However, single or more than two planting trays may be used in other design variations.

As further shown in the perspective view of a partial assemble of the aeroponic apparatus in FIG. 3, the manifold 330 rests under the planting trays 260 and is connected to an inlet pipe 344 with the tightening cap 333. The inlet pipe 344 goes through the tank inlet 212 (referenced in FIG. 2) and is connected to inline water filter 320. An outlet pipe 345 is connected to the tank outlet 213 and drains water from the water tank 210 to the pump 310. In a preferred embodiment, bulkhead connectors are used at the inlet/outlet to provide sealed connection to the inlet/outlet pipes.

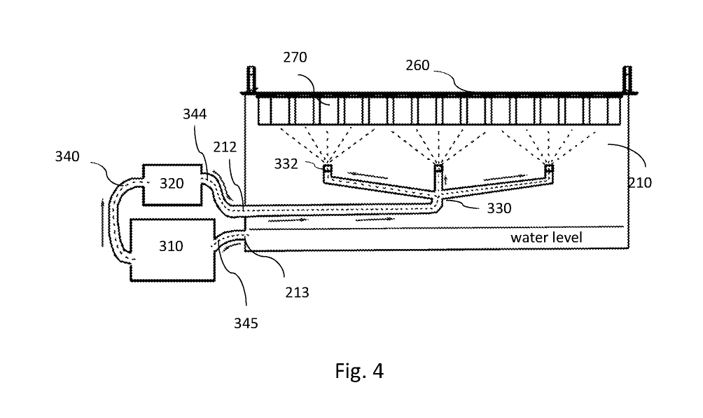

FIG. 4 is a diagram showing the water cycle of an embodiment of the aeroponic apparatus of the present invention. An external pump 310 pumps water through a section of connection pipe 340 to the inline water filter 320 for removal of debris and/or impurity. Purified water or nutritional solution is then directed by the inlet pipe 344 to enter the water tank 210 through the tank inlet 212. The inlet pipe 344 is connected to the manifold 330 located within the water tank 210. The pump 310 produces enough water pressure to deliver water through the manifold 330 and spray water mist from one or more nozzles 332 to the openings of the rooting tubes 270 as part of the planting tray 260. After the water drops back to the water tank 210, it is drained through a section of outlet pipe 345 back to the pump 310 via the tank outlet 213 located close to the bottom of the tank 210. Thus the water is cycled back to the pump 310 and is pumped out again to the filter 320, and subsequently to the manifold 330. This closed water cycle ensures minimum water waste.

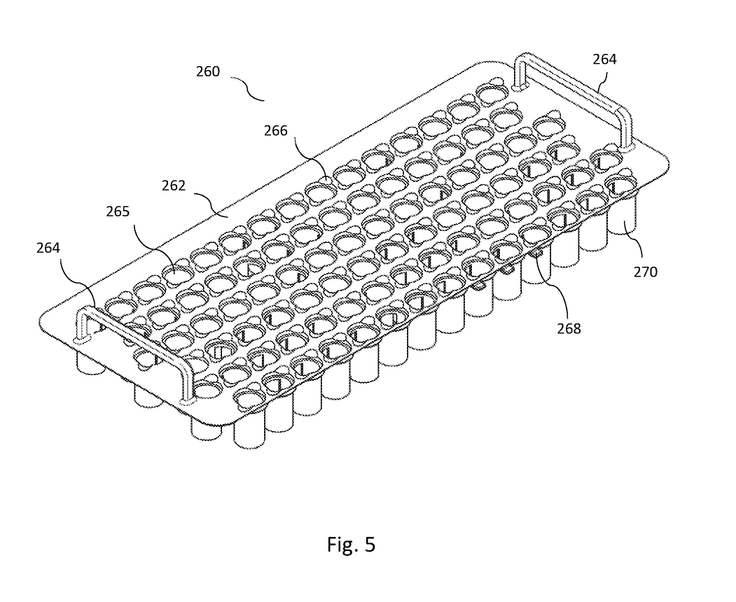

Another aspect of the present invention is the design of planting trays that are detachable, portable and with high performance. FIG. 5 is a perspective view of an embodiment of the planting tray 260 of the present invention. The planting tray 260 comprises a base board 262 as the supporting structure, two handles 264 that allows the user to move the plants in the cutting and planting stages without the need for moving the water reservoir, and a multitude of insert openings 265 and rooting tubes 270 to support the plants and to contain the plant root systems. In addition, the planting tray may comprises clips 268. When multiple planting trays are used, the clips 268 will allow the tray to support each other at their connection sides.

In a preferred embodiment, the insert openings 265 are circular in shape. Reusable or disposable inserted collars can be inserted to the insert openings 265 to hold the plant cuttings in the tray without falling through the rooting tubes to the water reservoir. In a preferred embodiment, the insert openings 265 have adjacent depress structure 266 to facilitate lifting the inserts/collars from the insert openings 265. The rooting tubes 270 are located under the insert openings 265 and integrated with the base board 262. These rooting tubes 270 provide support and separation of the plant roots. Effective root separation prevents the roots of neighboring plants from entangling and merging, and therefore is an import factor for constructing a compact and efficient aeroponic system with high plant density.

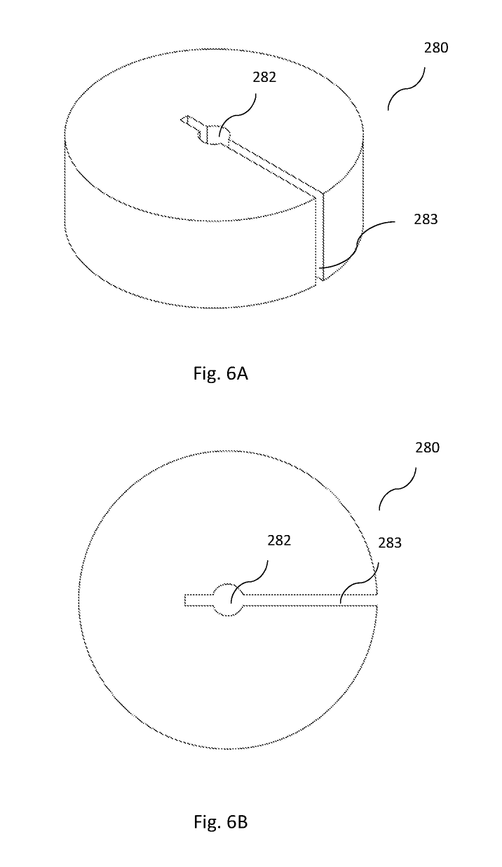

An embodiment of inserted collars 280 is illustrated in FIG. 6 (a) (perspective view) and FIG. 6 (b) (top view). In this embodiment, the inserted collar is cylindrical in overall shape and has an outer diameter that matches the size of the insert opening 265 to be able to snuggly fit in insert opening 265. The insert collar has a center hole 282 and a slit 283 cut through the thickness of the collar to hold a stem of a plant cutting.

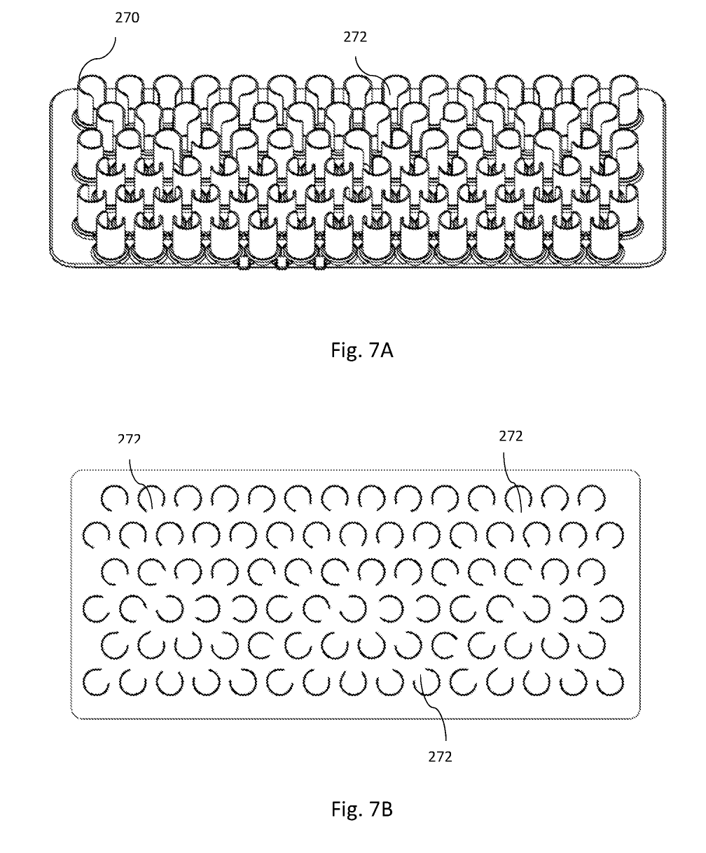

The rooting tubes 270 are also designed to optimize mist exposure of the roots while providing effective root separation. This is achieved by incorporating and arranging slotted side openings of the rooting tubes. The geometrical features of the rooting tubes 270 with the side openings 272 are illustrated by the bottom perspective view of an embodiment of the planting tray in FIG. 7 (a). The rooting tubes 272 are partial cylindrical in shape with side openings 272 facing different directions. As shown in the bottom view of an embodiment of the planting tray in FIG. 7(b), the direction of the rooting tube side openings 272 are arranged to match the directional distribution of the mist sprayed from the manifold nozzles 332. Also can be seen from FIGS. 7 (a) and (b), the limited size in the openings 272 as well as their non-uniform facing directions ensure an effective root separation from neighboring plants. In the example embodiment of FIG. 7, the planting tray is matched to a 3-nozzle misting arrangement. Each nozzle sprays a cone shaped distribution of mist, similar to as shown in water cycle diagram of FIG. 4. The directions of the rooting tube side openings 272 are arranged so that they face the direction of the stream of spray reaching the position of that particular rooting tube. With this guideline, when the manifold and nozzle designs are varied in other embodiments, the rooting tube side openings 272 are arranged to match the mist spray profiles, depending on the number, positions, and spray angular range of the nozzles. This design optimizes mist exposure of each individual root while providing effective root separation.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. An aeroponic plant growing system, comprising:
(A) a tub for catching and holding liquid;
(B) a pump;
(C) a liquid distribution manifold, the manifold having one or more output openings;
(D) means for spraying liquid out of the output openings of the manifold;
(E) one or more planting trays, the plating tray comprising
(a) a flat structure,
(b) a plurality of apertures in the flat structure, and
(c) a plurality of tube structures, each tube structure being connected to the flat structure and surrounding one of the said apertures, more than one of the tube structures having openings on the side wall, the facing directions of the openings being non-uniform across different tube structures;

2. The aeroponic plant growing system in claim 1, wherein the pump is located outside of the tub when the system is in use.

3. The aeroponic plant growing system in claim 2, further comprising a filter.

4. The aeroponic plant growing system in claim 1, wherein the tub further comprises means for draining liquid from the interior of the tub.

5. The aeroponic plant growing system in claim 1, further comprising a cover that can be fitted on top of the tub.

6. The aeroponic plant growing system in claim 5, wherein the cover is essentially made of a transparent or translucent material.

7. The aeroponic plant growing system in claim 5, wherein the cover comprises one or more venting apertures.

8. The aeroponic plant growing system in claim 1, wherein the planting tray further comprises one or more handles that can be used to lift and carry the planting tray.

9. The aeroponic plant growing system in claim 1, wherein the aeroponic plant growing system comprises more than one planting trays.

10. The aeroponic plant growing system in claim 9, wherein the planting trays further comprise clip structures on one or more sides of the flat structure of each planting tray, the clip structures allowing one or more sides of each planting tray to be supported by one or more other planting trays when the planting trays are placed on top of the tub.

11. The aeroponic plant growing system in claim 1, further comprising a means for fixing the manifold to the bottom surface to stabilize the relative position of the manifold relative to the other components of the system.

12. The aeroponic plant growing system in claim 1, wherein each side wall opening of the tube structures of the planting trays faces the traveling direction of the liquid sprayed from one of the output openings of the manifold reaching the position of the rooting tube where the opening resides in.

13. The aeroponic plant growing system in claim 1, further comprising one or more stem holding structures that can be fitted into the apertures in the planting tray, the stem holding structure having a hole at the center of the stem holding structure through which a stem of plant cutting can be inserted.

14. The aeroponic plant growing system in claim 13, wherein the stem holding structures are made of a biodegradable material.

15. The aeroponic plant growing system in claim 14, wherein the stem holding structures are made of cork.
